(19) United States
(12) Patent Application Publication
(10) Pub. No.: US 2026/0109114 A1
(43) Pub. Date: Apr. 23, 2026

(54) OPERATION MEMBER, INPUT DEVICE, AND PRODUCTION METHOD OF RESIN MOLDED ARTICLE

(71) Applicant: ALPS ALPINE CO., LTD., Tokyo (JP)

(72) Inventors: Takuya ISHIGURO, Miyagi (JP); Katsuhito ITO, Miyagi (JP); Tatsuya OBA, Miyagi (JP)

(21) Appl. No.: 19/429,130

(22) Filed: Dec. 22, 2025

Related U.S. Application Data
(63) Continuation of application No. PCT/JP2024/007776, filed on Mar. 1, 2024.

(30) Foreign Application Priority Data
Jun. 27, 2023 (JP) 2023-105261

(51) Int. Cl. B29C 65/16; B29C 65/00; B29L 31/30

(52) U.S. Cl. CPC B29C 65/1638; B29C 66/30221; B29C 66/73365; B29C 66/7352; B29L 2031/3008

(57) ABSTRACT

An operation member is provided and includes a first resin member having a plate shape and formed of a material that transmits laser light; and a second resin member having a tubular shape and formed of a material that absorbs the laser light. The first resin member and the second resin member are laser-welded in an opening included in the second resin member. The second resin member includes a bonding projection provided to project from an inner circumferential surface of the opening toward an inner diameter side of the second resin member. An outer circumferential portion of the first resin member is placed over the bonding projection of the second resin member. The outer circumferential portion of the first resin member is laser-welded to the bonding projection of the second resin member.

### CROSS-REFERENCE TO RELATED APPLICATIONS

This application is a continuation application of International Application No. PCT/JP2024/007776, filed on Mar. 1, 2024, and designated the U.S., which is based upon and claims priority to Japanese Patent Application No. 2023-105261, filed on Jun. 27, 2023, the entire contents of which are incorporated herein by reference.

### BACKGROUND

### 1. Field of the Invention

The present disclosure relates to an operation member, an input device, and a production method of a resin molded article.

### 2. Description of the Related Art

Japanese Laid-Open Patent Application Publication No. 2021-045849 discloses a technique that, in a state in which a lid is placed over a bonding surface of a housing, applies laser light to the lid from above to melt a resin of the bonding surface with the laser light, thereby laser-welding the lid to an opening of the housing.

### SUMMARY

An operation member according to an embodiment of the present disclosure includes: a first resin member having a plate shape and formed of a material that transmits laser light; and a second resin member having a tubular shape and formed of a material that absorbs the laser light. The first resin member and the second resin member are laser-welded in an opening included in the second resin member. The second resin member includes a bonding projection provided to project from an inner circumferential surface of the opening toward an inner diameter side of the second resin member. An outer circumferential portion of the first resin member is placed over the bonding projection of the second resin member. The outer circumferential portion of the first resin member is laser-welded to the bonding projection of the second resin member. The bonding projection includes a thick portion provided on an outer diameter side of the bonding projection, and a thin portion provided to project from the thick portion toward an inner diameter side of the bonding projection.

### BRIEF DESCRIPTION OF THE DRAWINGS

FIG. 1 is an external perspective diagram of a switch panel according to an embodiment of the present disclosure.

FIG. 2 is an exploded perspective diagram of an operation member according to an embodiment of the present disclosure.

FIG. 3 is a cross-sectional diagram of the operation member according to the embodiment.

FIG. 4 is a flowchart illustrating an example of a procedure of a production method of the operation member according to an embodiment of the present disclosure.

FIG. 5 is a partial enlarged cross-sectional diagram of a laser bonding portion included in the operation member according to the embodiment.

FIG. 6 is a partial enlarged cross-sectional diagram of a laser bonding portion included in an operation member according to a modified example of the embodiment.

FIG. 7 is an external perspective diagram of a jig according to an embodiment of the present disclosure.

FIG. 8 is a cross-sectional diagram of the jig according to the embodiment.

### DETAILED DESCRIPTION OF THE DISCLOSURE

In the operation device of Japanese Laid-Open Patent Application Publication No. 2021-045849, a portion of the melted resin flows to the inner diameter side of the opening (i.e., the rear side of the lid) to form into a burr. If a transparent lid is used, the burr is visible from the outside through the lid.

Hereinafter, embodiments of the present disclosure will be described with reference to the drawings. In the following description, for the sake of convenience, an X-axis direction in the drawings is defined as a front-rear direction, a Y-axis direction in the drawings is defined as a left-right direction, and a Z-axis direction in the drawings is defined as an up-down direction. Here, a positive X-axis direction is defined as a front direction, a positive Y-axis direction is defined as a right direction, and a positive Z-axis direction is defined as an upper direction. These indicate a relative positional relationship in the device, and do not limit an installation direction of the device and an operation direction of the device. All devices having the same relative positional relationship are encompassed in the scope of rights of the present invention, even if the installation direction and the operation direction are different.

### Configuration of Switch Panel 10

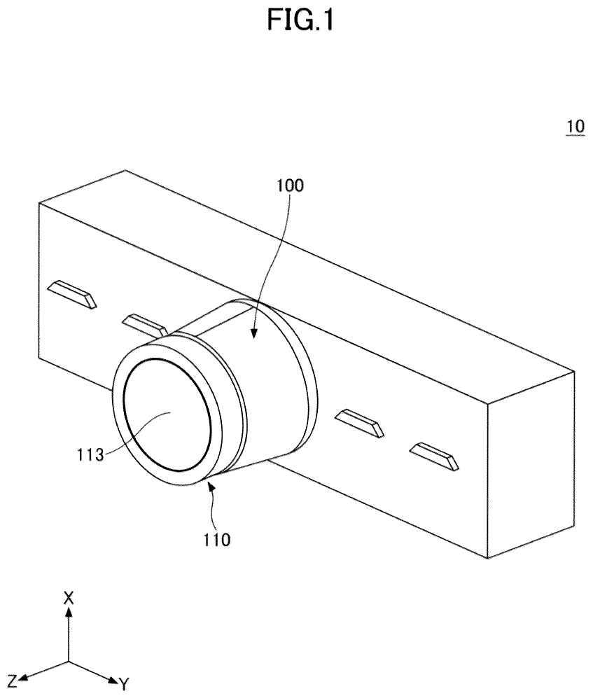

FIG. 1 is an external perspective diagram of a switch panel 10 according to an embodiment of the present disclosure. The switch panel 10 illustrated in FIG. 1 is a device mounted on a vehicle, such as an automobile or the like. As illustrated in FIG. 1, the switch panel 10 includes a rotation operation switch 100 at the center in the left-right direction (Y-axis direction), and the switch panel 10 projects toward an operator's side (positive Z-axis side).

The rotation operation switch 100 is an example of an “input device”. The rotation operation switch 100 includes an operation member 110. The operation member 110 is an example of a “resin molded article”. The operation member 110 has a substantially cylindrical outer shape, and is configured to undergo a rotation operation and a push operation performed by an operator.

In response to an operator performing the rotation operation or the push operation on the operation member 110, the rotation operation switch 100 can output a control signal corresponding to the rotation operation or the push operation to a control target device included in the vehicle (e.g., an audio, a car navigation system, an air conditioner, or an electronic shifter).

The rotation operation switch 100 includes a transparent plate 113 at the top surface of the operation member 110. The operation member 110 includes a liquid crystal display (LCD, not shown), which is an example of a “display device”. With this configuration, the rotation operation switch 100 enables display content displayed by the LCD to be visible from the outside through the transparent plate 113.

### Configuration of Operation Member 110

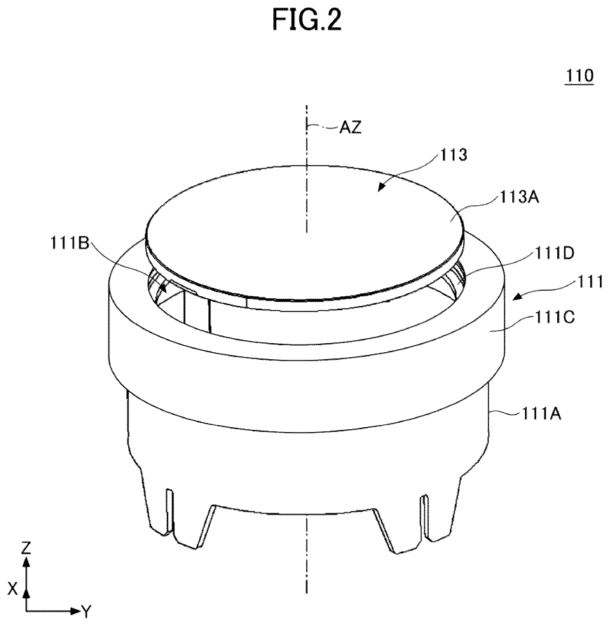

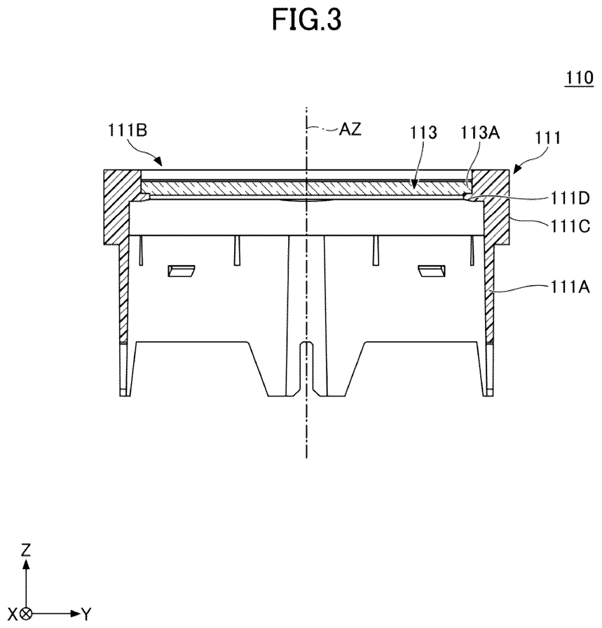

FIG. 2 is an exploded perspective diagram of the operation member 110 according to an embodiment of the present disclosure. FIG. 3 is a cross-sectional diagram of the operation member 110 according to the embodiment. As illustrated in FIGS. 2 and 3, the operation member 110 includes a casing 111 and a transparent plate 113.

The casing 111 is an example of a “second resin member”. The casing 111 is a substantially hollow cylindrical member having a center on an imaginary rotation axis AZ and formed of a resin material that absorbs laser light. However, the shape of the casing 111 is not limited to the hollow cylindrical shape, and may be a tubular shape having any other outer shape (e.g., a polygonal shape or an elliptical shape). The casing 111 has a substantially hollow cylindrical outer circumferential wall 111A extending in the up-down direction (Z-axis direction). The casing 111 includes a circular upper opening 111B at an upper end (an end on the positive Z-axis side) of the inner side (i.e., the interior of the hollow cylinder) of the outer circumferential wall 111A.

The casing 111 includes a gripping portion 111C at an upper end of the outer circumferential surface of the outer circumferential wall 111A. The gripping portion 111C is configured to be gripped by an operator who performs the rotation operation. The gripping portion 111C may be a portion having a width fixed in the up-down direction (Z-axis direction), having a partially increased outer diameter, and having an anti-slipping surface.

The casing 111 includes a bonding projection 111D provided to project from the inner circumferential surface of the upper opening 111B toward the inner diameter side (i.e., toward an imaginary rotation axis AZ). The bonding projection 111D is a portion over which an outer circumferential portion 113A of the transparent plate 113 is placed and to which the outer circumferential portion 113A of the transparent plate 113 is laser-welded.

In the rotation operation switch 100, the casing 111 is provided to be rotatable about the imaginary rotation axis AZ and to be movable in the up-down direction (Z-axis direction).

The transparent plate 113 is an example of the “first resin member”. The transparent plate 113 is a disk-shaped member formed of a resin material that transmits laser light. The transparent plate 113 is disposed in the circular upper opening 111B included in the casing 111, thereby closing the upper opening 111B.

The transparent plate 113 is laser-welded to the casing 111 in a state in which the transparent plate 113 is disposed in the upper opening 111B. Specifically, the entire circumferential portion of the outer circumferential portion 113A of the transparent plate 113 is placed over the bonding projection 111D included in the casing 111. Then, the entire circumferential portion of the outer circumferential portion 113A of the transparent plate 113 is laser-welded to the bonding projection 111D included in the casing 111. Thus, the transparent plate 113 is fixed to the casing 111, and is provided to be rotatable about the imaginary rotation axis AZ and movable in the up-down direction (Z-axis direction), along with the casing 111.

In the present embodiment, the transparent plate 113 is formed of a transparent resin material. Thus, the transparent plate 113 transmits display content displayed by a display device (not shown), such as an LCD or the like provided inside the casing 111, and enables a user to visually recognize the display content from a position above (positive Z-axis direction) the transparent plate 113.

In the rotation operation switch 100, when the operator grips the gripping portion 111C of the casing 111 to perform the rotation operation of the casing 111, the casing 111 and the transparent plate 113 of the operation member 110 integrally rotate about the imaginary rotation axis AZ (clockwise or counterclockwise). The rotation operation switch 100 includes a rotation detector (not shown) configured to detect this rotation. The rotation operation switch 100 outputs a detection signal of the detected rotation from the rotation detector to the outside, thereby controlling the control target device that is externally provided.

Also, when the operator performs the push operation on the upper surface of the transparent plate 113 downward (negative Z-axis direction), the casing 111 and the transparent plate 113 of the operation member 110 integrally move downward (negative Z-axis direction). The rotation operation switch 100 includes a push detector (not shown) configured to detect this movement. The rotation operation switch 100 outputs a detection signal of the detected movement from the push detector to the outside, thereby controlling the control target device that is externally provided.

### Procedure of Production Method of Operation Member 110

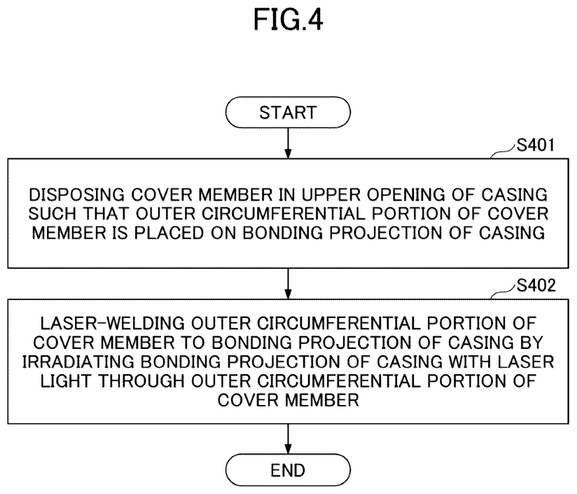

FIG. 4 is a flowchart illustrating an example of a procedure of a production method of the operation member 110 according to the embodiment of the present disclosure.

First, the transparent plate 113 (an example of a cover member) is disposed in the upper opening 111B of the casing 111 such that the outer circumferential portion 113A of the transparent plate 113 is placed over the bonding projection 111D of the casing 111 (step S401: a cover member disposing step).

Next, the outer circumferential portion 113A of the transparent plate 113 is laser-welded to the entire circumferential portion of the bonding projection 111D of the casing 111 by irradiating the entire circumferential portion of the bonding projection 111D of the casing 111 with laser light through the outer circumferential portion 113A of the transparent plate 113 (step S402: a laser welding step).

Specifically, in step S402, the laser light, with which the outer circumferential portion 113A of the transparent plate 113 is irradiated, passes through the outer circumferential portion 113A to reach the bonding projection 111D of the casing 111. Thus, the entire circumferential portion of the bonding projection 111D of the casing 111 absorbs the laser light to generate heat and to melt. As a result, the entire circumferential portion of the outer circumferential portion 113A of the transparent plate 113 is laser-welded to the bonding projection 111D of the casing 111.

### Detailed Configuration of Laser Bonding Portion

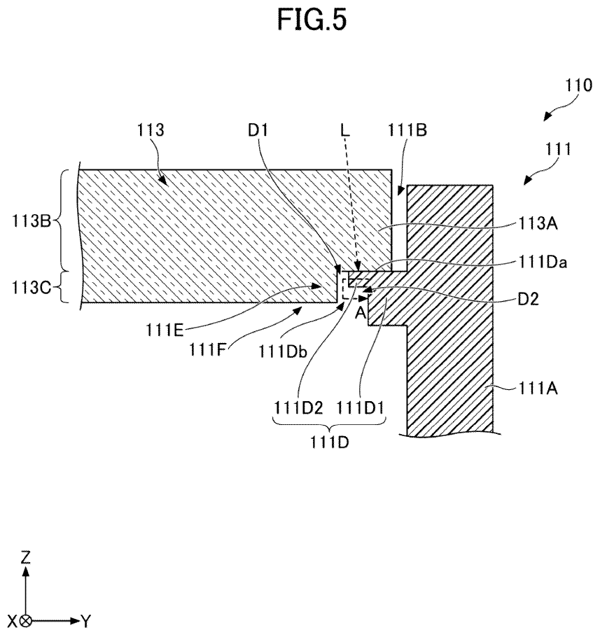

FIG. 5 is a partial enlarged cross-sectional diagram of a laser bonding portion included in the operation member 110 according to the embodiment.

As illustrated in FIG. 5, in the operation member 110 according to the embodiment, the outer circumferential portion 113A of the transparent plate 113 is placed over a bonding surface 111Da of the bonding projection 111D of the casing 111 in the upper opening 111B of the casing 111. Then, as illustrated in FIG. 5, when the outer circumferential portion 113A of the transparent plate 113 is irradiated with laser light L from above, the bonding surface 111Da of the bonding projection 111D of the casing 111 is melted by the laser light L transmitted through the outer circumferential portion 113A, and the outer circumferential portion 113A of the transparent plate 113 is laser-welded to the bonding surface 111Da.

Here, as illustrated in FIG. 5, the bonding projection 111D of the casing 111 includes a thick portion 111D1 provided on the outer diameter side of the bonding projection 111D, and a thin portion 111D2 provided to project from the thick portion 111D1 toward the inner diameter side of the bonding projection 111D.

Specifically, the thin portion 111D2 is provided to project from the upper end of the inner circumferential surface of the thick portion 111D1 toward the inner diameter side. The thickness of the thin portion 111D2 in the up-down direction is smaller than the thickness of the thick portion 111D1 in the up-down direction.

As a result, a small-diameter space 111E formed by the inner circumferential surface of the thin portion 111D2 is formed inside the bonding projection 111D in the casing 111, and a large-diameter space 111F formed by the inner circumferential surface of the thick portion 111D1 on the lower side (negative Z-axis side) of the small-diameter space 111E is formed inside the bonding projection 111D in the casing 111. The diameter of the large-diameter space 111F is larger than the diameter of the small-diameter space 111E.

As illustrated in FIG. 5, the transparent plate 113 includes a large-diameter portion 113B including the outer circumferential portion 113A placed over the bonding projection 111D, and a small-diameter portion 113C formed on the lower side (negative Z-axis side) of the large-diameter portion 113B. The small-diameter portion 113C includes no portion placed over the bonding projection 111D, and thus has a diameter smaller than that of the large-diameter portion 113B.

As illustrated in FIG. 5, the diameter of the large-diameter portion 113B of the transparent plate 113 is larger than the inner diameter of the thin portion 111D2 of the bonding projection 111D. Thus, the large-diameter portion 113B is placed over the bonding surface 111Da on the thin portion 111D2 and the thick portion 111D1 of the bonding projection 111D. With this configuration, according to the operation member 110 according to the embodiment, the transparent plate 113 can be supported by the thin portion 111D2 and the thick portion 111D1 of the bonding projection 111D. Thus, the bonding projection 111D can withstand a pressing force generated in response to a pressing operation performed on the transparent plate 113.

Since the diameter of the small-diameter portion 113C of the transparent plate 113 is smaller than the inner diameter of the thin portion 111D2 of the bonding projection 111D, the small-diameter portion 113C is fitted into a space inside the bonding projection 111D.

Especially, since the outer diameter of the small-diameter portion 113C of the transparent plate 113 is smaller than the inner diameter of the thin portion 111D2 of the bonding projection 111D, a first gap D1 is formed between the outer circumferential surface of the small-diameter portion 113C of the transparent plate 113 and the inner circumferential surface of the thin portion 111D2 of the bonding projection 111D.

Further, the thickness of the small-diameter portion 113C of the transparent plate 113 is larger than the thickness of the thin portion 111D2 of the bonding projection 111D. The lower portion of the outer circumferential surface of the small-diameter portion 113C of the transparent plate 113 is located below (negative Z-axis side) the thin portion 111D2 of the bonding projection 111D, and thus faces the inner circumferential surface of the thick portion 111D1.

A second gap D2 larger than the first gap DI is formed between the lower portion of the outer circumferential surface of the small-diameter portion 113C of the transparent plate 113, and the inner circumferential surface of the thick portion 111D1.

Here, in the operation member 110 according to the embodiment, when the bonding projection 111D is irradiated with laser light, there is a possibility that a portion of the melted resin of the bonding projection 111D flows from the first gap DI downward (negative Z-axis direction).

If the melted resin flowing downward from the first gap D1 flows to the inner diameter side of the first gap D1, there is a possibility that the melted resin becomes a burr visible from the outside through the transparent plate 113.

However, the operation member 110 according to the embodiment includes the second gap D2 below the first gap D1, and the second gap D2 is wider than the first gap on the outer diameter side. Thus, it is possible to suppress the melted resin flowing to the inner diameter side of the first gap D1 by flowing into the second gap D2 (see a dotted arrow A in FIG. 5).

Therefore, the operation member 110 according to the embodiment can suppress formation of a burr that is to become visible from the outside through the transparent plate 113.

### Modified Example of Operation Member 110

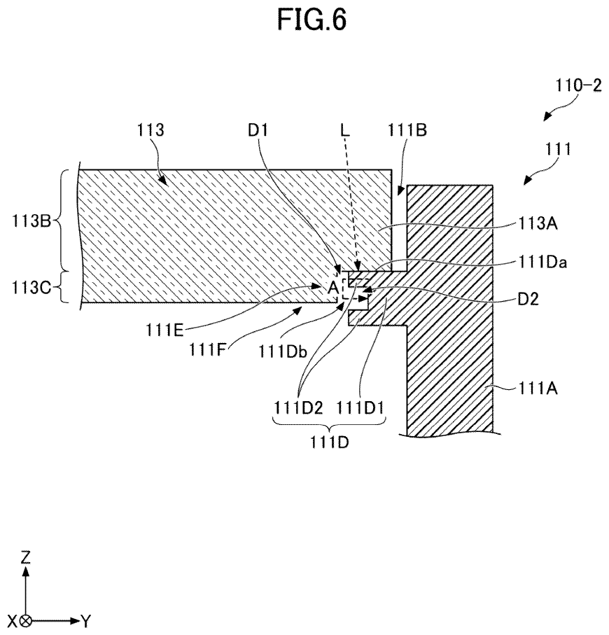

FIG. 6 is a partial enlarged cross-sectional diagram of a laser bonding portion included in an operation member 110-2 according to a modified example of the embodiment.

In the operation member 110 illustrated in FIG. S, a notch 111Db, formed toward the outer diameter side, is formed in the lower portion of the inner circumferential surface of the bonding projection 111D in the thickness direction (Z-axis direction), thereby forming the thin portion 111D2 on the upper side (positive Z-axis side) of the notch 111Db.

In the operation member 110-2 illustrated in FIG. 6, the notch 111Db, formed toward the outer diameter side, is formed in an intermediate portion of the inner circumferential surface of the bonding projection 111D in the thickness direction (Z-axis direction), thereby forming the thin portions 111D2 on the upper side (positive Z-axis side) and the lower side (negative Z-axis side) of the notch 111Db.

In this manner, the operation member 110-2 illustrated in FIG. 6 is different from the operation member 110 illustrated in FIG. 5 in terms of the position at which the second gap D2 is formed. However, the operation member 110-2 illustrated in FIG. 6 is the same as the operation member 110 illustrated in FIG. 5 in terms of including the second gap D2 formed on the lower side of the first gap D1 and wider than the first gap D1 on the outer diameter side.

Therefore, in the operation member 110-2 illustrated in FIG. 6 as in the operation member 110 illustrated in FIG. 5, the melted resin flowing below the first gap D1 flows into the second gap D2 (see a dotted arrow A in FIG. 6). This can suppress the melted resin flowing toward the inner diameter side of the first gap D1.

### Jig 200

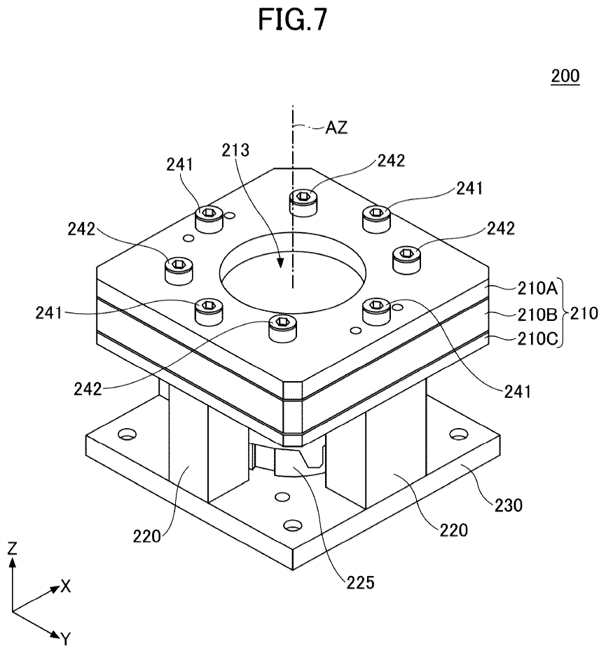

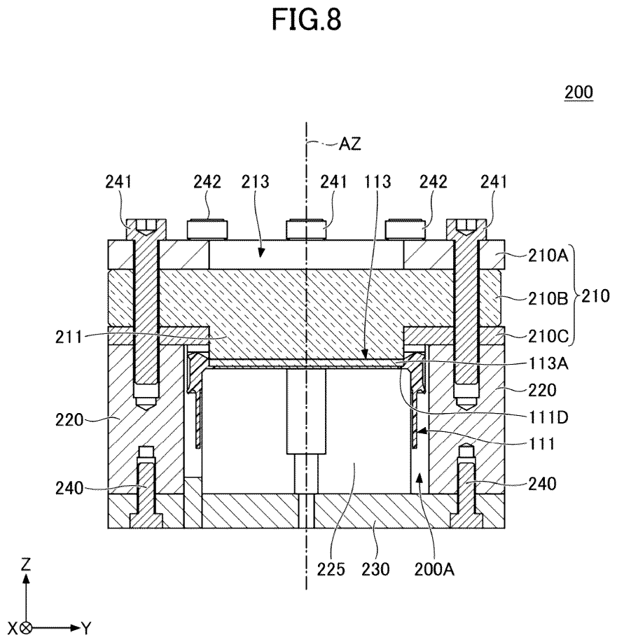

FIG. 7 is an external perspective diagram of a jig 200 according to an embodiment of the present disclosure. FIG. 8 is a cross-sectional diagram of the jig 200 according to the embodiment.

The jig 200 illustrated in FIGS. 7 and 8 can be used for the production of the operation member 110 according to the embodiment. The jig 200 is configured to laser-weld the outer circumferential portion 113A of the transparent plate 113 to the entire circumferential portion of the bonding projection 111D of the casing 111 in a state in which the outer circumferential portion 113A of the transparent plate 113 is pressed against the bonding projection 111D of the casing 111.

As illustrated in FIGS. 7 and 8, the jig 200 includes a lid 210, four struts 220, a holder 225, and a substrate 230.

The substrate 230 is a plate-like member configured to support the struts 220 from the lower side (negative Z-axis side). The holder 225 is provided at the center of the upper surface of the substrate 230. The holder 225 is a columnar member. As illustrated in FIG. 8, the holder 225 is fitted into the inner space of the casing 111 from the lower side (negative Z-axis side), thereby holding the casing 111 at a predetermined height in a space 200A enclosed by the struts 220.

Each of the four struts 220 is a columnar member provided on the substrate 230 to be upright. Each of the four struts 220 is configured to support the lid 210 from the lower side (negative Z-axis side). Each of the four struts 220 is screw-fixed to the substrate 230 by screws 240 that penetrate through the substrate 230.

As illustrated in FIG. 8, in the jig 200, the casing 111 and the transparent plate 113 to be laser-welded are disposed in the space 200A enclosed by the four struts 220.

The lid 210 is a flat plate provided on the struts 220, and is configured to close the upper portion of the space 200A enclosed by the four struts 220. The lid 210 can be screw-fixed to the four struts 220 by four screws 241 that penetrate through the lid 210.

The lid 210 has a laminated structure in which a substrate 210A, a transparent glass plate 210B, and a reinforcing plate 210C are laminated sequentially from the upper side (positive Z-axis side). In the lid 210, the substrate 210A, the glass plate 210B, and the reinforcing plate 210C are laminated and fixed to each other by four screws 242 that penetrate through the substrate 210A, the glass plate 210B, and the reinforcing plate 210C.

As illustrated in FIG. 8, a columnar pressing portion 211 projecting downward (negative Z-axis direction) is formed at the center of the rear surface of the glass plate 210B of the lid 210. As illustrated in FIG. 8, by pressing the upper surface of the transparent plate 113 by the pressing portion 211 in a state in which the lid 210 is screw-fixed to each of the struts 220, it is possible to press the outer circumferential portion 113A of the transparent plate 113 against the bonding projection 111D of the casing 111.

Also, a circular opening 213 is formed at the center of the substrate 210A of the lid 210.

Thus, the jig 200 can easily and accurately laser-weld the outer circumferential portion 113A of the transparent plate 113 to the entire circumferential portion of the bonding projection 111D of the casing 111 by applying laser light, from above the opening 213, toward the bonding projection 111D disposed substantially below the outer circumference of the opening 213.

Although the embodiments of the present disclosure have been described above in detail, the present disclosure is not limited to these embodiments, and various modifications or alterations are possible within the intent of the present disclosure defined in claims recited.

For example, the shape of the casing Ill is not limited to the hollow cylindrical shape, and may be any other tubular shape. Also, the shape of the transparent plate 113 is not limited to the disk shape, and may be any other plate shape. The application of the operation member 110 is not limited to the rotation operation switch 100, and the operation member 110 may be used for any other input device.

According to the operation member according to the embodiment, it is possible to suppress the formation of a burr that is visible from the outside.

What is claimed is:

1. An operation member, comprising:
a first resin member having a plate shape and formed of a material that transmits laser light; and
a second resin member having a tubular shape and formed of a material that absorbs the laser light, wherein
the first resin member and the second resin member are laser-welded in an opening included in the second resin member,
the second resin member includes a bonding projection provided to project from an inner circumferential surface of the opening toward an inner diameter side of the second resin member,
an outer circumferential portion of the first resin member is placed over the bonding projection of the second resin member,
the outer circumferential portion of the first resin member is laser-welded to the bonding projection of the second resin member, and
the bonding projection includes a thick portion provided on an outer diameter side of the bonding projection, and a thin portion provided to project from the thick portion toward an inner diameter side of the bonding projection.

2. The operation member according to claim 1, wherein
the first resin member is a transparent plate.

3. The operation member according to claim 2, wherein
the second resin member is a casing.

4. The operation member according to claim 1, wherein
the first resin member includes a large-diameter portion placed over the bonding projection, and a small-diameter portion fitted into a space inside the bonding projection, a diameter of the small-diameter portion being smaller than a diameter of the large-diameter portion,
a thickness of the small-diameter portion is larger than a thickness of the thin portion of the bonding projection,
a portion of an outer circumferential surface of the small-diameter portion faces an inner circumferential surface of the thin portion of the bonding projection across a first gap, and
another portion of the outer circumferential surface of the small-diameter portion faces an inner circumferential surface of the thick portion of the bonding projection across a second gap that is larger than the first gap.

5. The operation member according to claim 4, wherein
the diameter of the large-diameter portion of the first resin member is larger than a diameter of the thin portion of the bonding projection.

6. The operation member according to claim 4, wherein
the thin portion and the thick portion of the second resin member are formed by a notch included in the second resin member, and
the notch is formed toward the outer diameter side in an inner circumferential surface of the bonding projection.

7. An input device, comprising,
the operation member of claim 1; and
a display device disposed in an inner region of the second resin member, wherein
display content of the display device is visible from outside through the first resin member.

8. The input device according to claim 7, wherein
the operation member is provided to be configured to undergo a rotation operation.

9. A production method of a resin molded article including a first resin member having a plate shape and formed of a material that transmits laser light, and a second resin member having a tubular shape and formed of a material that absorbs the laser light, the production method comprising:
disposing the first resin member in an opening included in the second resin member such that an outer circumferential portion of the first resin member is placed over a bonding projection provided in the second resin member to project from an inner circumferential surface of the opening toward an inner diameter side of the second resin member; and
laser-welding the outer circumferential portion of the first resin member to the bonding projection of the second resin member by irradiating the bonding projection of the second resin member with laser light through the outer circumferential portion of the first resin member, wherein
the bonding projection includes a thick portion provided on an outer diameter side of the bonding projection, and a thin portion provided to project from the thick portion toward the inner diameter side of the bonding projection.
